(19) United States
(12) Patent Application Publication
(10) Pub. No.: US 2026/0213911 A1
(43) Pub. Date: Jul. 23, 2026

(54) SUB-BAND CONFIGURATION FOR SUBBAND NON-OVERLAPPING FULL DUPLEX

(71) Applicant: Nokia Technologies Oy, Espoo (FI)

(72) Inventors: Jie GUO, Zhejiang (CN); Youngsoo YUK, Seoul (KR); Claudio ROSA, Randers (DK); Jing Yuan SUN, Beijing (CN); Nhat-Quang NHAN, Reims (FR)

(73) Assignee: Nokia Technologies Oy, Espoo (FI)

(21) Appl. No.: 19/143,595

(22) PCT Filed: Dec. 28, 2022
(86) PCT No.: PCT/CN2022/142952

§ 371 Date: Jun. 26, 2025

(51) Int. Cl. H04L 5/00; H04W 72/21

(52) U.S. Cl. CPC H04L 5/0094; H04W 72/21

(57) ABSTRACT

Embodiments of the present disclosure relate to devices, methods, apparatuses and computer readable storage media of subband configuration for subband non-overlapping full duplex (SBFD). The method comprises receiving, from a second device, an indication indicative of a start of a resource allocated for a transmission from the first device to the second device, the indication comprising an offset relative to a predetermined subband of a control resource set; and performing the transmission at least based on the indication. In this way, less bits may be used for indicating the UL subband frequency position on SBFD slots and the signalling overhead may be further reduced for both SIB and RRC.

### FIELD

Embodiments of the present disclosure generally relate to the field of telecommunication and in particular to devices, methods, apparatuses and computer readable storage media of subband configuration for subband non-overlapping full duplex (SBFD).

### BACKGROUND

In general, two duplexing modes are supported in 3rd Generation Partnership Project (3GPP) New Radio (NR), namely Frequency Division Duplex (FDD) for paired bands and Time Division Duplex (TDD) for unpaired bands. In TDD, the time domain resource is split between downlink and uplink. Allocation of a limited time duration for the uplink in TDD would result in reduced coverage, increased latency, and reduced capacity.

### SUMMARY

In general, example embodiments of the present disclosure provide a solution of subband configuration for SBFD.

In a first aspect, there is provide a first device. The first device comprises at least one processor; and at least one memory storing instructions that, when executed by the at least one processor, cause the first device at least to perform: receiving, from a second device, an indication indicative of a start of a resource allocated for a transmission from the first device to the second device, the indication comprising an offset relative to a predetermined subband of a control resource set; and performing the transmission at least based on the indication.

In a second aspect, there is provide a second device. The second device comprises at least one processor; and at least one memory storing instructions that, when executed by the at least one processor, cause the first device at least to perform: transmitting, to a first device, an indication indicative of a start of a resource allocated for a transmission from the first device to the second device, the indication comprising an offset relative to a predetermined subband of a control resource set; and receiving the transmission from the first device at least based on the indication.

In a third aspect, there is provided a method. The method comprises receiving, from a second device, an indication indicative of a start of a resource allocated for a transmission from the first device to the second device, the indication comprising an offset relative to a predetermined subband of a control resource set; and performing the transmission at least based on the indication.

In a fourth aspect, there is provided a method. The method comprises transmitting, to a first device, an indication indicative of a start of a resource allocated for a transmission from the first device to the second device, the indication comprising an offset relative to a predetermined subband of a control resource set; and receiving the transmission from the first device at least based on the indication.

In a fifth aspect, there is provided an apparatus comprising means for receiving, from a second device, an indication indicative of a start of a resource allocated for a transmission from the first device to the second device, the indication comprising an offset relative to a predetermined subband of a control resource set; and means for performing the transmission at least based on the indication.

In a sixth aspect, there is provided an apparatus comprising means for transmitting, to a first device, an indication indicative of a start of a resource allocated for a transmission from the first device to the second device, the indication comprising an offset relative to a predetermined subband of a control resource set; and means for receiving the transmission from the first device at least based on the indication.

In a seventh aspect, there is provided a computer readable medium having a computer program stored thereon which, when executed by at least one processor of a device, causes the device to carry out the method according to the third aspect or the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings.

FIG. 1 illustrates an example environment in which example embodiments of the present disclosure may be implemented;

FIG. 2 shows a signaling chart illustrating a process of subband configuration for SBFD according to some example embodiments of the present disclosure;

FIGS. 3A-3C show examples of UL subband according to some example embodiments of the present disclosure;

FIG. 4 shows a flowchart of an example method of subband configuration for SBFD according to some example embodiments of the present disclosure;

FIG. 5 shows a flowchart of an example method of subband configuration for SBFD according to some example embodiments of the present disclosure;

FIG. 6 shows a simplified block diagram of a device that is suitable for implementing example embodiments of the present disclosure; and

FIG. 7 shows a block diagram of an example computer readable medium in accordance with some embodiments of the present disclosure.

Throughout the drawings, the same or similar reference numerals may represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein may have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture includes a Centralized Unit (CU) and a Distributed Unit (DU) at an IAB donor node. An IAB node includes a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

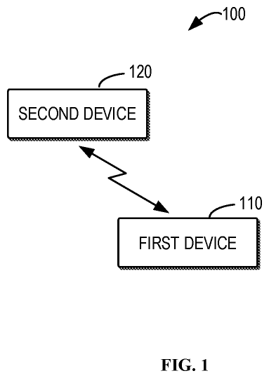

FIG. 1 shows an example communication network 100 in which embodiments of the present disclosure may be implemented. As shown in FIG. 1, the communication network 100 may comprise a first device 110. Hereinafter the first device 110 may also be referred to as a terminal device or a UE.

The communication network 100 may further comprise a second device 120. Hereinafter the second device 120 may also be referred to as a gNB or a network device. The first device 110 may communicate with the second device 120.

It is to be understood that the number of network devices and terminal devices shown in FIG. 1 is given for the purpose of illustration without suggesting any limitations. The communication network 100 may include any suitable number of network devices and terminal devices.

In some example embodiments, links from the second device 120 to the first device 110 may be referred to as a downlink (DL), while links from the first device 110 to the second device 120 may be referred to as an uplink (UL). In DL, the second device 120 is a transmitting (TX) device (or a transmitter) and the first device 110 is a receiving (RX) device (or receiver). In UL, the first device 110 is a TX device (or transmitter) and the second device 120 is a RX device (or a receiver).

Communications in the communication environment 100 may be implemented according to any proper communication protocol(s), includes, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, includes but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

3GPP has agreed to initiate a study item on the evolution of duplexing operation in NR. One of the objectives of this study item is to allow simultaneous DL and UL transmission on different PRBs within an unpaired wideband NR cell. Some duplexing schemes such as TDD, FDD and SBFD are proposed for supporting the simultaneous DL and UL transmissions.

For semi-static configuration of subband frequency locations for SBFD operation, at least explicit indication of frequency location of UL subband is required. However, how to indicate the frequency location of UL subband may still need to be discussed.

Embodiments of the present disclosure proposes a mechanism for indicating the frequency location of UL subband. In this solution, the first device 110 receives, from the second device 120, an indication indicative of a start of a resource allocated for a transmission from the first device 110 to the second device 120. The indication comprises an offset relative to a predetermined subband of a control resource set. Then the first device 110 performing the transmission at least based on the indication.

Example embodiments of the present disclosure will be described in detail below with reference to the accompanying drawings.

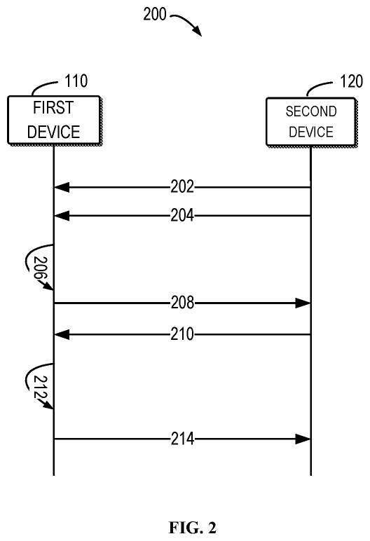

Reference is now made to FIG. 2, which shows a signaling chart 200 for communication according to some example embodiments of the present disclosure. As shown in FIG. 2, the signaling chart 200 involves a first device 110 and a second device 120. For the purpose of discussion, reference is made to FIG. 1 to describe the signaling chart 200.

Now the reference is made to FIG. 2, the second device 120 may transmit 202, for example via a Master Information Block, MIB, the Control Resource Set #0 (CORESET0) configuration to the first device. The second device 120 may also indicate a frequency band allowed to be used, for example, for the transmission between the first device 110 and the second device 120.

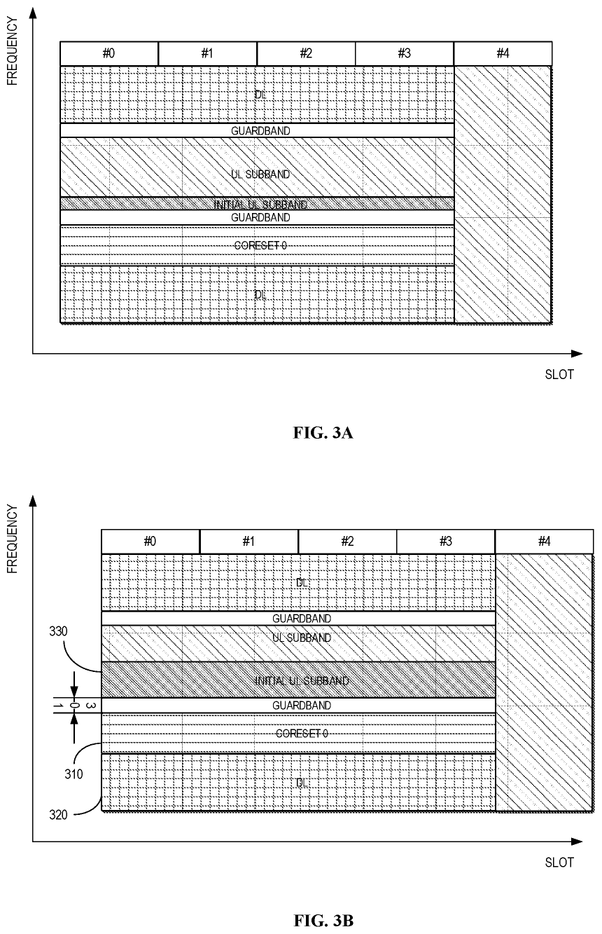

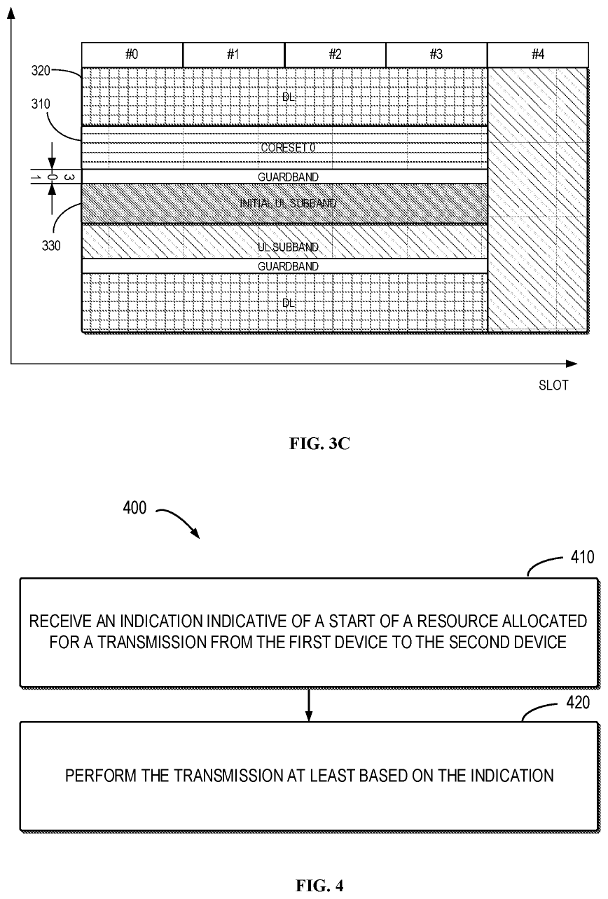

Furthermore, the second device 120 may also indicate a number of slots/symbols where the frequency band may be split into multiple subbands and wherein at least one subband is used for DL transmissions and at least one subband is used for UL transmissions, i.e., SBFD slots/symbols, and locations of the number of slots/symbols in a radio frame. The second device 120 may also indicate a number of slots/symbols where the entire frequency band is used for DL transmissions or UL transmissions, i.e., non-SBFD slots/symbols, and locations of the number of slots/symbols in a radio frame. As shown in FIG. 3A, the slots/symbols in Slot #0/#1/#2/#3 are SBFD slots/symbols, and the slots/symbols in Slot #4 is non-SBFD slots/symbols, e.g., the entire frequency band in the Slot #4 is only used for UL transmissions.

The second device 120 may transmit 204, for example via a System Information Block (SIB), an indication indicative of a frequency location of an initial UL subband. For example, the frequency location of an initial UL subband may be indicated by an offset relative to the subband of frequency allocated for CORESET0. The term “an initial UL subband” used hereinafter may be referred as to UL subband(s) used for an UL transmission for an access procedure of the first device 110. It is to be understood that the second device 120 may transmit indication indicative of the frequency location of the initial UL subband along with any other configuration (e.g., the CORESET0 configuration as mentioned above). That is, the action 204 may be performed together with the action 202.

In some example embodiments, the offset may be positive or negative depending on whether the subband allocated for CORESET0 is located in an upper DL subband or a lower DL subband, i.e., whether the subband allocated for CORESET0 is located in the DL subband that has higher or lower frequency location than UL subband.

The first device 110 may determine 206 the initial UL subband based on the subband allocated for CORESET0 and the offset.

As an option, the offset is positive and is relative to the top of the subband allocated for CORESET0, if the CORESET0 is located in the lower DL subband, for example, the DL subband lower than a threshold sudband. Then the initial UL subband may be determined from lower frequency to higher frequency in this case, i.e., starting RB<ending RB. As shown in FIG. 3B, the CORESET0 310 is located in the lower DL subband 320, the offset 301 should be positive and is relative to the top of the subband allocated for CORESET0 320, then the initial UL subband 330 is located above the subband allocated for CORESET0 320 and is separated by the offset 301.

As another option, the offset is negative and is relative to the bottom of the subband allocated for CORESET0, if CORESET0 is located in the upper DL subband, for example, the DL subband higher than a threshold sudband. Then the initial UL subband may be determined from higher frequency to lower frequency in this case, i.e., starting RB>ending RB. As shown in FIG. 3C, the CORESET0 310 is located in the upper DL subband 320, the offset 301 should be negative and is relative to the bottom of the subband allocated for CORESET0 320, then the initial UL subband 330 is located lower than the subband allocated for CORESET0 320 and is separated by the offset 301.

Alternatively or additionally, the offset may also be used for determining a guardband to be used for avoiding the inter-subband interference. As an option, the frequency location from the top of the subband allocated for CORESET0 to the start of the initial UL subband is determined as a guardband, if the CORESET0 is located in the lower DL subband, for example, the DL subband lower than a threshold sudband. As shown in 3B, the guardband is located from the top of the subband allocated for CORESET0 310 to the start of the initial UL subband 330.

As another option, the frequency location from the bottom of the subband allocated for CORESET0 to the start of the initial UL subband is determined as a guardband, if the CORESET0 is located in the upper DL subband, the DL subband higher than a threshold sudband. As shown in 3C, the guardband is located from the bottom of the subband allocated for CORESET0 310 to the start of the initial UL subband 330.

It is to be understood that similar guardband size may be applied to the other side of UL subband if UL subband is allocated in between two DL subbands.

Furthermore, the number of RBs of initial UL subband may also be indicated in the SIB. For example, SIB1 may define the number of RBs for initial UL subband. As another option, the number of RBs is equal to CORESET0 size scaled by a ratio. This ratio may be indicated in the SIB. Alternatively, the ratio may also be specified. For example, the ratio may be 1/8, 1/4, 1/3, 1/2, 1, 2, . . . .

It may also be specified that the number of RBs of initial UL subband may be same with CORESET0 size. In this case, there is no additional information about the number of RBs of initial UL subband in the SIB1.

It is to be understood that the frequency position of initial SBFD UL subband may also be relative to other broadcasting DL channel/signal, e.g., Synchronization Signal and PBCH block (SSB).

Back to FIG. 2, the first device 110 may perform 208 the initial UL transmission on the initial UL subband. For example, the first device 110 may transmit the UL common channel, such as Physical Uplink Control Channel (PUCCH), Physical Random Access Channel (PRACH), Sounding Reference Signal (SRS), Physical Uplink Shared Channel (PUSCH), etc., within the initial UL subband.

In some example embodiments, expect for the SIB1, the second device 120 may also transmit 210, to the first device 110, an indication indicative of a frequency location of UL subband. Hereinafter the term “UL subband” may be referred to as UL subband(s) used for UL transmission(s) after the initial UL transmission. For example, the second device 120 may transmit the UL subband indication via a Radio Resource Control (RRC) signalling.

As an option, the UL subband indication may comprise an offset relative to the subband of frequency allocated for CORESET0, which may be used for narrowing down a range configurable for the number of RBs.

As another option, the indication may also be indicative of the number of RBs and a start of RBs of UL subband. For example, the frequency location of the UL subband may be indicated in a similar way as the location and bandwidth of BWP is configured, by using a Resource Indication Value (RIV) indicator for the start RB and number of RBs of the UL subband. Specifically, resource allocation field consists of a RIV corresponding to a starting virtual resource block (RDₛₜₐᵣₜ) and a length in terms of contiguously allocated resource blocks L_{RBs}. The resource indication value is defined by:

```
    if (L_{RBs} −1) ≤ └N_{BWP}^{size} / 2┘ then
      RIV = N_{BWP}^{size} (L_{RBs} −1) + RBₛₜₐᵣₜ
else
  RIV = N_{BWP}^{size} (N_{BWP}^{size} − L_{RBs} + 1) + (N_{BWP}^{size} − 1 − RBₛₜₐᵣₜ)
```

where L_{RBs}≥1 and shall not exceed

$${N}_{BWP}^{size} - {RB}_{start} .$$

If the SIB1 set positive offset relative to the frequency position of coreset0, the Bandwidth part of size

$${N}_{BWP}^{size}$$

### PRBs is:

Total BW−NumofRBs (CRB0 to top of CORESET0)

If the SIB1 set negative offset relative to the frequency position of coreset0, the Bandwidth part of size

$${N}_{BWP}^{size}$$

### PRBs is:

NumofRBs (CRB0 to bottom of CORESET0)

Alternatively, the number of RBs for UL subband and the start RB is coreset0 edge with positive or negative offset include guardband or exclude guardband may be defined in a SIB, e.g., SIB 1.

Alternatively, the indication of the UL subband may also comprise a ratio for the first device 110 to determine the number of RBs for the UL subband based on the initial UL subband scaled by the ratio. For example, the ratio may be 1/4, 1/2, 1, 2, 3, 4, . . . .

Alternatively, the indication of the UL subband may also indicate that the starting RB position for the UL subband is equal to initial UL subband start RB or end RB.

As described above, based on the indication received from the second device 120, the first device 110 may determine 212 the starting RB position for the first device 110 sending the UL channel, such as PUCCH, PRACH, SRS, PUSCH, etc., in SBFD slots and within the range of the UL subband. Then the first device 110 may transmit 214 such UL channel in the determined UL subband.

By introducing a mechanism for the initial UL subband indication and/or the UL subband indication, less bits may be used for indicating the UL subband frequency position on SBFD slots and the signalling overhead may be further reduced for both SIB and RRC.

FIG. 4 shows a flowchart of an example method 400 of subband configuration for SBFD according to some example embodiments of the present disclosure. The method 400 may be implemented at the first device 110 as shown in FIG. 1. For the purpose of discussion, the method 400 will be described with reference to FIG. 1.

At 410, the first device 110 receives, from a second device, an indication indicative of a start of a resource allocated for a transmission from the first device to the second device, the indication comprising an offset relative to a predetermined subband of a control resource set.

At 420, the first device performs the transmission at least based on the indication.

In some example embodiments, the indication indicates a first subband allocated for an initial uplink transmission from the first device to the second device.

In some example embodiments, the first device may receive the indication in a SIB.

In some example embodiments, the number of resource blocks of the initial uplink transmission equals to a size of the control resource set, or the size of the control resource set scaled by a ratio.

In some example embodiments, the number of resource blocks of the initial uplink transmission is indicated in a SIB.

In some example embodiments, the first subband is determined based on the predetermined subband and the offset, and a value of the offset is positive and is relative to the top of the predetermined subband if the predetermined subband is located in a downlink subband lower than a threshold subband, or the value of the offset is negative and is relative to the bottom of the predetermined subband if the predetermined subband is located in a downlink subband higher than a threshold subband.

In some example embodiments, the first device may determine, based on the offset, a guardband for avoiding an inter-subband interference.

In some example embodiments, if the predetermined subband is located in a downlink subband lower than a threshold subband, the first device may determine a frequency location from the top of the predetermined subband to the start of the first subband as the guardband, or if the predetermined subband is located in a downlink subband higher than a threshold subband, the first device may determine a frequency location from the bottom of the predetermined subband to the start of the first subband as the guardband.

In some example embodiments, the indication indicates a second subband allocated for a further uplink transmission to the second device after the initial uplink transmission. In some example embodiments, the first device may receive this indication in a RRC signalling.

In some example embodiments, the first device may determine the number of resource blocks and a starting resource block of the second subband from the radio resource control signalling.

In some example embodiments, the number of resource blocks of the second subband is predetermined, and a starting resource block of the second subband is determined based on an edge of the control resource set and the offset.

In some example embodiments, the number of resource blocks of the second subband is equal to the number of resource blocks of the first subband scaled by a ratio, and a starting resource block of the second subband is a starting resource block or an ending resource block of the first subband.

In some example embodiments, a configurable range of the number of resource blocks of the second subband is narrowed by the offset relative to the predetermined subband.

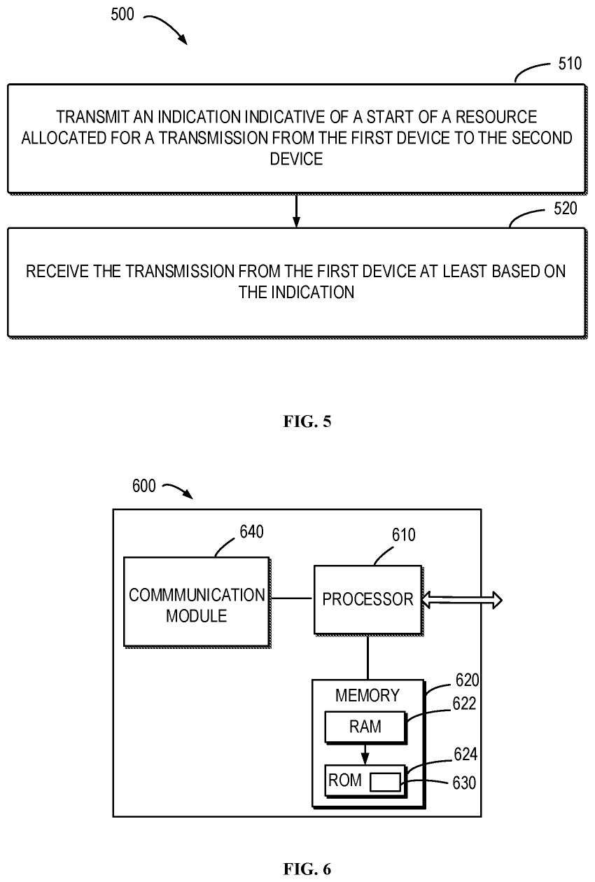

FIG. 5 shows a flowchart of an example method 500 of subband configuration for SBFD according to some example embodiments of the present disclosure. The method 500 may be implemented at the second device 120 as shown in FIG. 1. For the purpose of discussion, the method 500 will be described with reference to FIG. 1.

At 510, the second device transmits, to a first device, an indication indicative of a start of a resource allocated for a transmission from the first device to the second device, the indication comprising an offset relative to a predetermined subband of a control resource set.

At 520, the second device receives the transmission from the first device at least based on the indication.

In some example embodiments, the indication indicates a first subband allocated for an initial uplink transmission to the second device.

In some example embodiments, the second device may transmit the indication in a SIB.

In some example embodiments, the number of resource blocks of the initial uplink transmission equals to a size of the control resource set, or the size of the control resource set scaled by a ratio.

In some example embodiments, the number of resource blocks of the initial uplink transmission is indicated in a SIB.

In some example embodiments, the first subband is determined based on the predetermined subband and the offset, and a value of the offset is positive and is relative to the top of the predetermined subband if the predetermined subband is located in a downlink subband lower than a threshold subband, or the value of the offset is negative and is relative to the bottom of the predetermined subband if the predetermined subband is located in a downlink subband higher than a threshold subband.

In some example embodiments, a guardband is determined, based on the offset, for avoiding an inter-subband interference.

In some example embodiments, if the predetermined subband is located in a downlink subband lower than a threshold subband, a frequency location from the top of the predetermined subband to the start of the first subband is determined as the guardband, or if the predetermined subband is located in a downlink subband higher than a threshold subband, a frequency location from the bottom of the predetermined subband to the start of the first subband is determined as the guardband.

In some example embodiments, the indication indicates a second subband allocated for a further uplink transmission to the second device after the initial uplink transmission. In some example embodiments, the second device may transmit the indication in a RRC signalling.

In some example embodiments, the number of resource blocks of the second subband is predetermined, and a starting resource block of the second subband is determined based on an edge of the control resource set and the offset.

In some example embodiments, the number of resource blocks of the second subband is equal to the number of resource blocks of the first subband scaled by a ratio, and a starting resource block of the second subband is a starting resource block or an ending resource block of the first subband.

In some example embodiments, a configurable range of the number of resource blocks of the second subband is narrowed by the offset relative to the predetermined subband.

In some example embodiments, an apparatus capable of performing the method 400 (for example, implemented at the first device 110) may include means for performing the respective steps of the method 400. The means may be implemented in any suitable form. For example, the means may be implemented in a circuitry or software module.

In some example embodiments, the apparatus comprises means for receiving, from a second device, an indication indicative of a start of a resource allocated for a transmission from the first device to the second device, the indication comprising an offset relative to a predetermined subband of a control resource set; and means for performing the transmission at least based on the indication.

In some example embodiments, an apparatus capable of performing the method 500 (for example, implemented at the second device 120) may include means for performing the respective steps of the method 500. The means may be implemented in any suitable form. For example, the means may be implemented in a circuitry or software module.

In some example embodiments, the apparatus comprises means for means for transmitting, to a first device, an indication indicative of a start of a resource allocated for a transmission from the first device to the second device, the indication comprising an offset relative to a predetermined subband of a control resource set; and means for receiving the transmission from the first device at least based on the indication.

FIG. 6 is a simplified block diagram of a device 600 that is suitable for implementing example embodiments of the present disclosure. The device 600 may be provided to implement a communication device, for example, the first device 110 or the second device 120 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

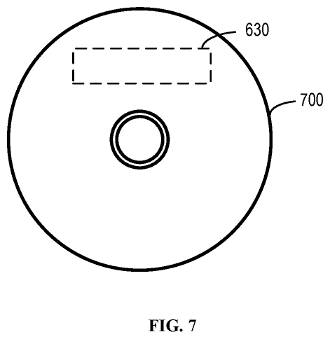

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provides at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
at least one processor; and
at least one memory storing instructions that, when executed by the at least one processor, cause the first device at least to perform:
receiving, from a second device, an indication indicative of a start of a resource allocated for a transmission from the first device to the second device, the indication comprising an offset relative to a predetermined subband of a control resource set; and
performing the transmission at least based on the indication.

2. The first device of claim 1, wherein the indication indicates a first subband allocated for an initial uplink transmission from the first device to the second device.

3. The first device of claim 2, wherein receiving the indication comprises:
receiving the indication in a system information block.

4. The first device of claim 2, wherein the number of resource blocks of the initial uplink transmission equals to a size of the control resource set, or the size of the control resource set scaled by a ratio.

5. The first device of claim 4, wherein the number of resource blocks of the initial uplink transmission is indicated in a system information block.

6. The first device of claim 2, wherein the first subband is determined based on the predetermined subband and the offset, and wherein
a value of the offset is positive and is relative to the top of the predetermined subband if the predetermined subband is located in a downlink subband lower than a threshold subband, or
the value of the offset is negative and is relative to the bottom of the predetermined subband if the predetermined subband is located in a downlink subband higher than a threshold subband.

7. The first device of claim 2, further comprising:
determining, based on the offset, a guardband for avoiding an inter-subband interference.

8. The first device of claim 7, wherein determining the guardband comprises:
if the predetermined subband is located in a downlink subband lower than a threshold subband, determining a frequency location from the top of the predetermined subband to the start of the first subband as the guardband, or
if the predetermined subband is located in a downlink subband higher than a threshold subband, determining a frequency location from the bottom of the predetermined subband to the start of the first subband as the guardband.

9. The first device of claim 2, wherein the indication indicates a second subband allocated for a further uplink transmission to the second device after the initial uplink transmission.

10. The first device of claim 9, wherein receiving the indication comprises:
receiving the indication in a radio resource control signalling.

11. The first device of claim 10, further comprising:
determining the number of resource blocks and a starting resource block of the second subband from the radio resource control signalling.

12. The first device of claim 9, wherein the number of resource blocks of the second subband is predetermined, and
a starting resource block of the second subband is determined based on an edge of the control resource set and the offset.

13. The first device of claim 9, wherein the number of resource blocks of the second subband is equal to the number of resource blocks of the first subband scaled by a ratio, and
a starting resource block of the second subband is a starting resource block or an ending resource block of the first subband.

14. The first device of claim 9, wherein a configurable range of the number of resource blocks of the second subband is narrowed by the offset relative to the predetermined subband.

15. A second device comprising:
at least one processor; and
at least one memory storing instructions that, when executed by the at least one processor, cause the second device at least to perform:
transmitting, to a first device, an indication indicative of a start of a resource allocated for a transmission from the first device to the second device, the indication comprising an offset relative to a predetermined subband of a control resource set; and
receiving the transmission from the first device at least based on the indication.

16. The second device of claim 15, wherein the indication indicates a first subband allocated for an initial uplink transmission to the second device.

17. The second device of claim 16, wherein transmitting the indication comprises:
transmitting the indication in a system information block.

18. The second device of claim 16, wherein the number of resource blocks of the initial uplink transmission equals to a size of the control resource set, or the size of the control resource set scaled by a ratio.

19-23. (canceled)

24. The second device of claim 23, wherein transmitting the indication comprises:
transmitting the indication in a radio resource control signalling.

25-27. (canceled)

28. A method comprising:
receiving, at a first device and from a second device, an indication indicative of a start of a resource allocated for a transmission from the first device to the second device, the indication comprising an offset relative to a predetermined subband of a control resource set; and
performing the transmission at least based on the indication.

29-32. (canceled)
